(19) United States
(12) Patent Application Publication
(10) Pub. No.: US 2004/0076436 A1
(43) Pub. Date: Apr. 22, 2004

(54) Bulk optics packaged unit and system including the same

(75) Inventors: Ernest E. Bergmann, Bethlehem, PA (US); Margaret A. Ghiron, Allentown, PA (US); Neal H. Thorsten, Lebanon, NJ (US); Harvey L. Wagner, Hereford, PA (US)

Correspondence Address: HITT GAINES P.C., P.O. BOX 832570, RICHARDSON, TX, 75083, US

(73) Assignee: Agere Systems Inc., Allentown, PA (US)

(21) Appl. No.: 10/273,914

(22) Filed: Oct. 18, 2002

(51) Int. Cl. G02B 6/28; H04J 14/02

(52) U.S. Cl. 398/82; 385/24; 398/164

(57) ABSTRACT

The present invention provides an optical device and a subsystem incorporating the same. In an advantageous embodiment, the optical device includes a signal multiplexer element, and a signal distributor element, both contained within a single optic package unit such that signals introduced therein propagate in free space between the signal multiplexer element and the signal distributor element.

### TECHNICAL FIELD OF THE INVENTION

The present invention is directed, in general, to an optics device and, more specifically, to optical multiplexer elements and optical distributor elements integrated as a bulk optic packaged unit and a sub-system employing the same.

### BACKGROUND OF THE INVENTION

There is a need for higher pump power for Erbium Doped Fiber Amplifiers (EDFA) and other fiber amplifiers and for higher reliability through redundancy. One can achieve higher pump powers by taking a multitude of individual laser pump sources and combining their individual powers to form a more powerful source than would otherwise be readily available. Where several EDFA pump needs exist, the power of several pumps can be pooled together and then subdivided to satisfy the multiple needs. The higher reliability of this arrangement lies in that if not all of the pump lasers remain operational, all of the needs will continue to be supplied.

Wavelength division and polarization dependent multiplexing is used to achieve power concentration. Sub-systems can be composed of known optical devices (e.g., wavelength division multiplexer devices, or “WDM” devices) combined with optical signal distributing devices using interconnecting fiber optic cabling (“pigtails”) in an effort to provide such power concentration, as well as signal direction and power redundancy. However, by interconnecting optics devices with fiber optic pigtails or other waveguides, the user introduces factors tending to ultimately reduce the overall reliability and capability of the sub-system. As a result, fiber optic connected components experience increased signal loss, reduced reliability, interfacing difficulty, and use more space.

Using fiber optic pigtails or other waveguides to interconnect optics components also substantially increases the physical size of the optical circuit. As the number of cables and the required bandwidth of optical circuits increase, more and more space is needed within the parent enclosure and surrounding structure to accommodate the sub-system.

Accordingly, what is needed in the art is an integrated optic device incorporating improvements to the above-mentioned disadvantages.

### SUMMARY OF THE INVENTION

To address the above-discussed deficiencies of the prior art, the present invention provides an optical device and a system incorporating the same. In an advantageous embodiment, the optical device includes an optical multiplexer element and an optical distributor element. The optical multiplexer element and the optical distributor element are located between an optical input and an optical output and contained within a single optic package unit such that signals propagate in a free space between said signal multiplexer element and said signal distributor element rather than along conventional waveguides.

The foregoing has outlined an advantageous embodiment of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

The invention is best understood from the following detailed description, when read with the accompanying FIGURES. It is emphasized that in accordance with the standard practice in the optoelectronic industry, various features may not be drawn to scale. In fact, the dimensions of the various features may be arbitrarily increased or reduced for clarity of discussion. Reference is now made to the following descriptions taken in conjunction with the accompanying drawings, in which:

FIG. 1A illustrates one example of a prior art splicing together multiplexers and distributors;

FIG. 1B illustrates another example of a prior art splicing together multiplexers and distributors;

FIG. 1C illustrates yet another example of a prior art splicing together multiplexers and distributors;

FIG. 2 illustrates a plan view of the bulk optic packaged unit forming the basis of the present invention;

FIG. 3 illustrates a plan view of the bulk optic packaged unit forming the basis of an alternative embodiment of the present invention;

FIG. 4 illustrates a plan view of the bulk optic packaged unit forming the basis of an alternative embodiment of the present invention;

FIG. 5 illustrates a plan view of the bulk optic packaged unit forming the basis of an alternative embodiment of the present invention;

FIG. 6 illustrates a detail view of the critical components of the bulk optic packaged unit illustrated in FIG. 2;

FIG. 7 illustrates an optoelectronic system also forming an embodiment and incorporating the bulk optic packaged unit illustrated in FIGS. 2 through 5; and

FIG. 8 illustrates a flow diagram of an embodiment of a method of fabricating an optical device constructed in accordance with the principles of the present invention.

### DETAILED DESCRIPTION

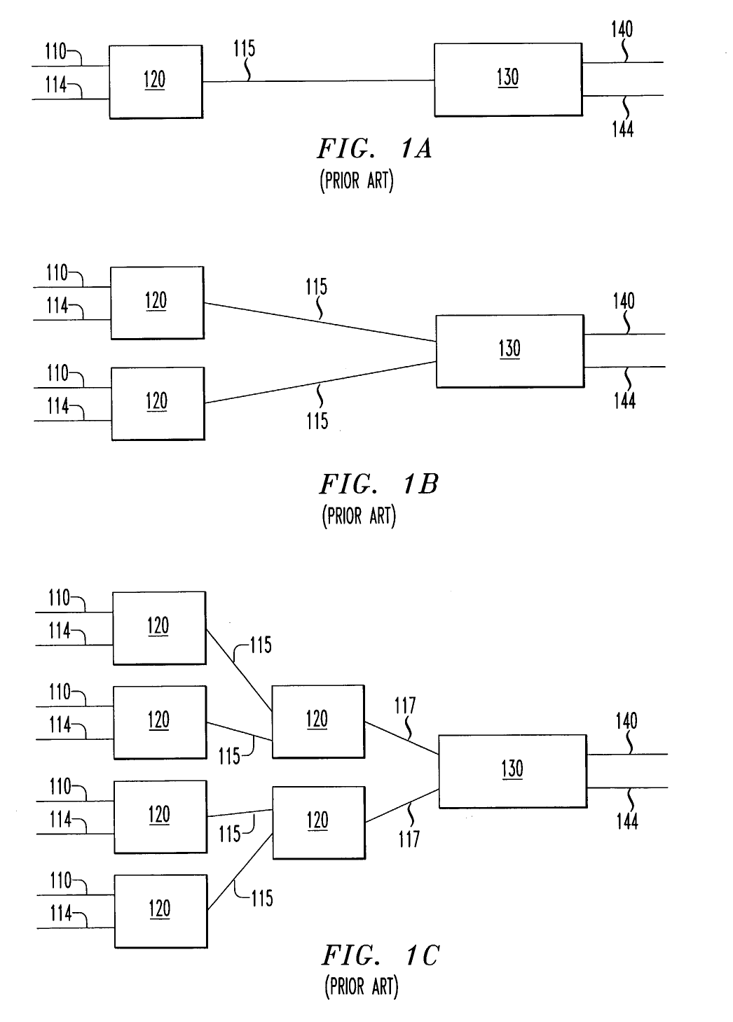

FIGS. 1A-1C illustrate examples of prior art devices that use discrete, fiber-optic-pigtailed devices. These devices are readily formed using existing designs of devices that are then spliced together with fiber optics to form the desired function. In FIG. 1A and FIG. 1B, wavelength division multiplexer elements (“WDMs”) 120 combine optical input signals received from pigtailed fiber optic cable inputs 110, 114, and transmit the combined signals via pigtailed fiber optic cables 115 to optical signal distributor elements 130 such as WDMs, where the combined signal is re-distributed to pigtailed fiber optic cables 140, 144. The apparatus illustrated in FIG. 1C works in a similar fashion, thereby combining multiple cascaded WDMs 120 to multiplex four pairs of signals from fiber optic cable pigtails 110, 114, the resulting signals being guided by pigtailed fiber optic cables 117 to distributor element 130 and re-distributed as equivalent signals 140, 144.

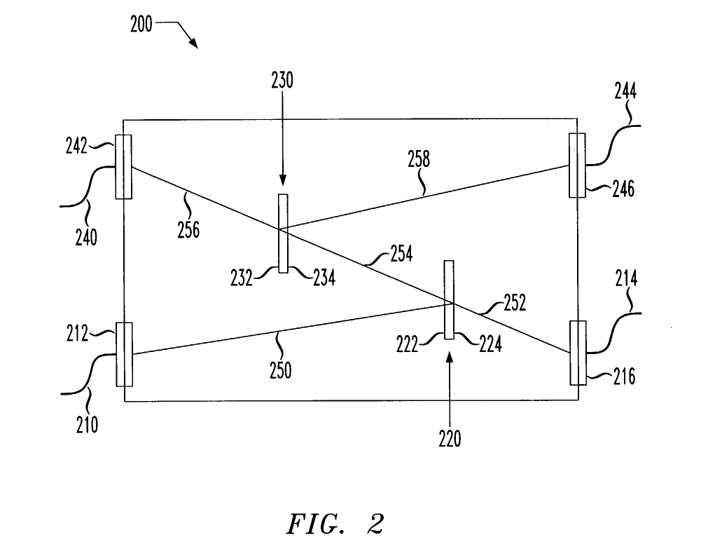

Referring now to FIG. 2, illustrated is a plan view of a bulk optic packaged unit 200 that forms the basis for the present invention. As used herein, “bulk optics” pertains to the use of collimated signals that propagate in free space between optical components as opposed to wave-guided optical connections. This is in contrast to conventional systems where fiber optic pigtails are employed between functions and/or components. In such conventional systems, the fiber optic pigtails are generally coupled to collimated signal portions of the device by collimators. A collimator usually consists of a fiber termination and a focusing means, generally a GRIN (GRadient INdex) lens or aspherical lens, that converts between a sharp focus at the fiber end and the collimated signal. The fiber termination may consist of a fiber end embedded and epoxied inside a capillary that is polished, anti-reflection coated, and aligned to the lens, or the fiber termination may be fused directly to the lens.

Pigtails 210, 214 introduce light signals into the bulk optic packaged unit 200 through optical inputs 212, 216. The optical inputs 212, 216 may be embodied in various forms as discussed below. In one advantageous embodiment, the optical inputs 212, 216 may include a conventional signal collimating device (not shown) that converts the signal between a sharp focus at the fiber optic pigtail's end and the collimated light signal desired for bulk optics manipulation.

The optical input 212 directs the input light signal 250 from the pigtail 210 toward an anti-reflective surface 222 of a wavelength division multiplexer element (WDM) 220. The optical input 216 directs the input light signal 252 from the pigtail 214 toward a transflective surface 224 of the WDM element 220. As used herein a transflective surface is one that can either reflect or transmit a signal, depending on its wavelength. With the correct choice of wavelengths, positions, directions and conventional optical coatings on the WDM element 220, the light signal 250 reflects off of the WDM element 220 (e.g., surface 224) and the input light signal 252 transmits through the WDM element 220 so that these two signals 250, 252 are superimposed in position and direction to form a common, multiplexed, more powerful collimated signal 254 that is directed toward an anti-reflective surface 234 of an optical signal distributor element 230. It is in this manner that the WDM element 220 performs the multiplexing function in combining input light signals 250, 252.

The multiplexed signal 254 traveling from the WDM element 220 is split by the optical signal distributor element 230 into two approximately equal signals 256, 258. One of the signals 258 is formed by partial reflection of the multiplexed signal 254 off a reflective surface 232 of the optical signal distributor element 230, while the other signal 256 is formed by partial transmission through the optical signal distributor element 230. The resulting two signals 256, 258 are directed toward optical outputs 242, 246, respectively, where they are directed into pigtailed fiber optic output cables 240, 244, respectively. The optical outputs 242, 246 may include signal focusing devices (not shown), such as a GRadient INdex lens or aspherical lens, converting the signal between the collimated signal and a sharp focus at a fiber termination (also not shown).

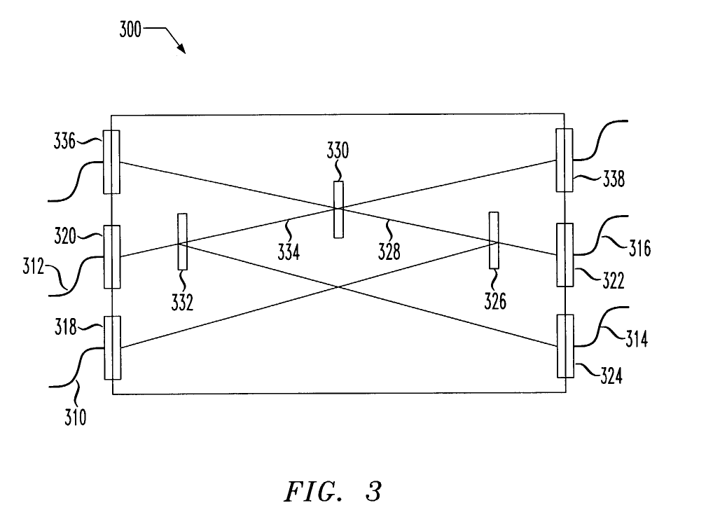

FIG. 3 illustrates a plan view of a bulk optic packaged unit 300 that forms the basis for an alternative embodiment of the present invention. Pigtails 310, 312, 314 and 316 introduce light signals into the bulk optic packaged unit 300 through optical inputs 318, 320, 322 and 324. The optical inputs 318, 320, 322 and 324 may be of the same type as previously discussed. Thus, in this embodiment, four inputs are ultimately redistributed to two outputs. Input signals from the optical inputs 318 and 322 are combined by a WDM element 326 to produce a combined signal 328 directed toward an optical signal distributor element 330 from the right. Input signals from the optical inputs 320 and 324 are combined by a WDM element 332 to produce a combined signal 334 directed toward the optical signal distributor element 330 from the left. Thus, in a manner analogous as set forth above, the WDM element 326 and the WDM element 332 act as WDM elements providing combined outputs directed toward the optical signal distributor element 330. The optical signal distributor element 330 acts by partial reflection and also by partial transmission to mix the powers incident on itself to produce mixed outputs at the optical outputs 336 and 338.

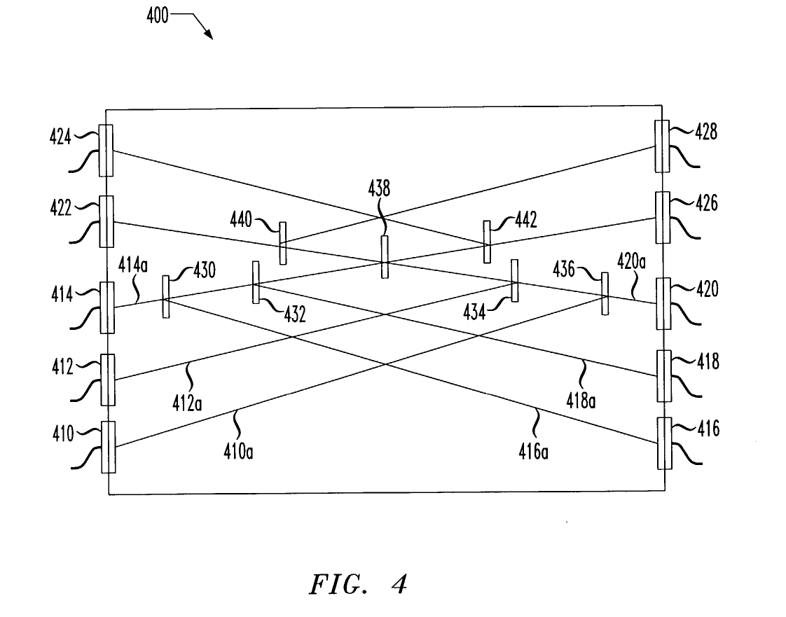

FIG. 4 illustrates yet another embodiment of a bulk optical packaged unit 400 in which six optical inputs 410, 412, 414, 416, 418 and 420 and four optical outputs 422, 424, 426 and 428 are present. The input signals 410a, 412a, 414a, 416a, 418a and 420a are combined at WDM elements 430, 432, 434 and 436, as illustrated, and the resulting power is directed from both sides of the bulk optical packaged unit 400 to an optical signal distributor element 438. The optical signal distributor element 438 then mixes the incident signals and directs equal powers toward optical signal distributor elements 440 and 442 as shown. If a different split in power which is independent of which input might fail is desired, the optical signal distributor element 440 can be engineered to split the (half total) power it receives and to make its two outputs 422 and 428 unequal by some desired amount. Similarly, the optical signal distributor element 442 can be engineered to split the (half total) power it receives and to make its two outputs 424 and 426 unequal by some desired amount. It can be seen that this embodiment can be designed to have fewer or more combined inputs.

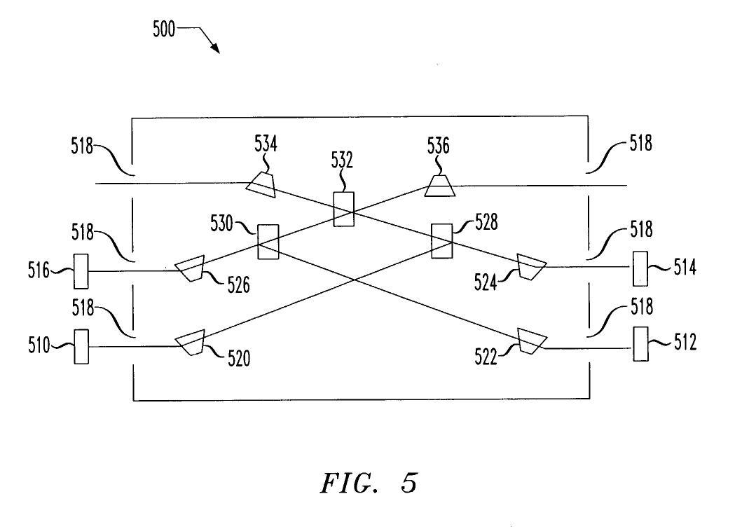

FIG. 5 illustrates yet another embodiment of a bulk optical packaged unit 500 in accordance with the present invention. In this particular embodiment, input light signals are directed from optical pumps 510, 512, 514, and 516, through optical inputs 518, which may be openings or windows-518 formed in the bulk optic packaged unit 500. The windows 518 may be formed from glass, plastic, or any other transparent material. Such windows 518 may have a conventional anti-reflective coating to minimize the reflective losses that the windows 518 may have on the input signals. Such windows 518 may be used in other embodiments, including those illustrated in FIGS. 1 through 4.

Optical pumps 510, 512, 514, and 516 direct input signals toward directing devices 520, 522, 524 and 526, respectively. Directing devices 520, 522, 524 and 526 may be a device for redirecting a light signal, such as a prism or mirror, or a plurality of such devices. If an input is conveyed by a waveguide, then proximate to the window, a collimator is used to convert the waveguided light into an approximately collimated signal. Directing devices 520 and 524 direct their input signals to WDM element 528 and directing devices 522 and 526 direct their input signals to WDM element 530. In this particular configuration, the signals from WDM elements 528 and 530 are then directed to optical signal distributor element 532 where the signals are split into output signals and directed through the openings 518 by directing devices 534 and 536 as illustrated. With the correct choice of wavelengths, polarizations, positions, directions and conventional optical coatings on WDM elements 528 and 530, the input signals may be multiplexed into a more powerful collimated signal that is directed toward the optical signal distributor element 532.

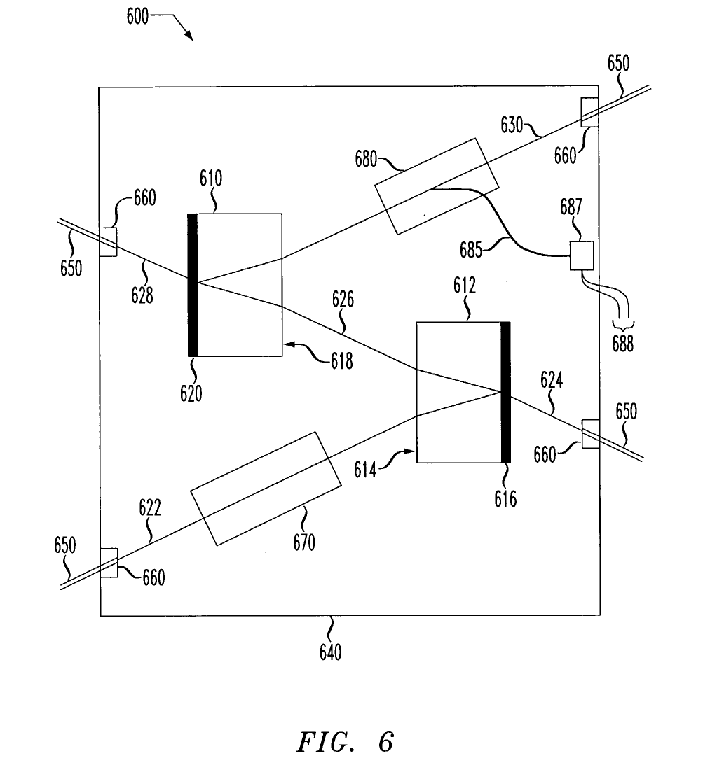

Turning now to FIG. 6, with continued references to FIGS. 2 through 5, illustrated is an enlarged view of an optical signal distributor element 610 and a WDM element 612 as discussed with respect to the embodiments shown in FIGS. 1 through 5. The optical signal distributor element 610 and WDM element 612 may comprise part of a bulk-optics package 600. WDM element 612 is formed from transparent material preferably having an anti-reflective coating on one surface 614, and a multiplexer coating on another surface 616. The multiplexer coating may preferably be generated by an alternating set of layers of controlled thickness of a low and a high index of refraction materials, as is understood by one knowledgeable in the art for optical thin film coatings. In one advantageous embodiment, the multiplexer coating comprises 10 or more layers. The optical signal distributor element 610 is also formed from a transparent material having an anti-reflective coating on one surface 618, and a distributor element coating on another surface 620. The distributor element coating may preferably be generated by a suitably designed alternating set of layers as is understood by one knowledgeable in the art. In one advantageous embodiment, the distributor element coating comprises 5 or more layers. The anti-reflective coatings may preferably be a multilayer design having 1 or more layers. In general, the reflective surfaces 616 and 620 are substantially parallel. Input light signals 622, 624, incident on WDM element 612, are combined into the resulting multiplexed signal 626, which is incident on the optical signal distributor element 610. The optical signal distributor element 610 splits the multiplexed signal 626 into substantially equal signals 628, 630.

An advantage of the present invention is the direct communication among the inputs, multiplexers, distributors and outputs, in that signal loss and interfacing difficulty are substantially decreased as compared to communication via fiber optic pigtails or other waveguides. It is also an advantage of the present invention that the elimination of waveguides interconnecting the optical components contributes to decreasing the physical size of the optical sub-system, its housing, and the surrounding structure.

While the reflective surface 616 is shown on the right side of the WDM element 612 and the reflective surface 620 is shown on the left side of the optical signal distributor element 610, which side of each element is anti-reflective (AR) coated and which side has the reflective coating can be a matter of design. Such a reversal merely works to slightly alter the separation of the resultant signals, a result that may be preferable in some applications. To the extent that the AR coating is not perfect, reversing the orientation shown in FIG. 6 may reduce reflective loss in some of the paths.

In addition, the reflective surfaces 616, 620 represent a wide variety of coatings which may be used pursuant to the present invention, such as alternating layers of SiO₂ and TiO₂, each of which posses a different index of refraction. The specific reflective coating selected is dependent upon a number of factors, including angles of incidence of the light signals 622, 624, 626, desired distribution percentages of the distributed signals 628, 630, and orientation of all bulk optics components in relation to one another. Also, although the reflective surfaces 616, 620 have been described as substantially parallel, it should be understood that they may possess slight wedge angles, typically less than 1 degree, so that any slight reflections inadvertently occurring at the anti-reflective surfaces 614, 618 will deviate slightly away from the signal and slightly away from the return signal directions so as to avoid possible interference effects and avoid coupling and/or interference of the signals. Such lack of complete parallelism may result in a slight lack of complete parallelism in the main signal directions.

The angle of incidence is a compromise between maximizing the separation of inputs and outputs, where a large angle of incidence is better, and minimizing the complexity of the coatings used for the WDM element and optical signal distributor element. For angles of incidence greater than about 10 degrees, the coating behaviors for TE polarization (E field in perpendicular to the page) and TM polarization (E field in the plane of the page) tend to be noticeably different. Such a noticeable difference is acceptable in the present invention when the wavelengths to be combined have adequate separation. Specific design of WDM element and distributor element coatings within the above description should be known to those skilled in the art.

Moreover, while the multiplexer elements discussed above have been described as wavelength division multiplexer elements, those skilled in the art understand that the present invention may also employ polarization division (or polarization dependent) multiplexer elements instead or in combination therewith. Such polarization dependent multiplexer elements may include conventional polarization dependent combiners, such as birefringent crystals or glass/wire grids.

Furthermore, the optical signal distributor elements described above may also be replaced with conventional polarization dependent distributor elements. For example, the optical signal distributor elements described above may be conventional polarization dependent splitter elements, including the conventional polarization elements discussed above and used in “reverse.”

Additionally, embodiments of the present invention also include mixed combinations of wavelength division elements and polarization dependent elements. For instance, one embodiment of a bulk optics package of the present invention may include one or more wavelength division multiplexer elements and one or more polarization dependent splitter elements.

In one embodiment, the elimination of waveguides interconnecting the optical components may be further aided by coupling the optical signal distributor element 610 and multiplexer element 612 to a common substrate 640. In such embodiments, the input light signals 622, 624, and/or the substantially equal signals 628, 630, may propagate along waveguides 650 coupled to the substrate 640 by coupling means 660. Coupling means 660 may include epoxy or other mechanical means. In addition, coupling means 660 may directly couple waveguides 650 to the substrate 640, or such coupling may be indirect, such as through a collimator intervening and coupled to the waveguide 650 and the substrate 640. Similarly, in one embodiment, coupling means 660 may be a collimator.

In addition, a conventional tap filter 680 (e.g., a 2% tap filter, as known to those skill in the art) or other reflective filter may be located in close proximity to the coupling means 660 or another component within the bulk optics package 600. A sample of the energy that is entering the optical package 600 by an optical fiber or pigtail 650 may thereby be rerouted out of the optical package 600 to another component (not shown). In the embodiment shown, the tap filter 680 transmits a sample via a waveguide or pigtail 685 to a conventional optical detector 687 (e.g., a PIN diode), such that the signal sample may be analyzed. For instance, the optical inputs 622, 624 or the optical outputs 628, 630 may thus be analyzed. Of course, such sampling via the tap 680 may occur anywhere along the signal path, and the optical detector 687 may be located outside of or within the bulk-optics package 600.

In one embodiment, the optical detector 687 may have a partially reflective coating on an input thereof, such that only a fraction of the incident optical energy is transmitted to the optical detector, and the remainder of the energy is reflected. The optical detector 687 may also have electrical conductors 688 or other means for conventional data communication with components (not shown) outside of the package 600.

A conventional optical isolator 670 is also shown in FIG. 6. The optical isolator 670 may be located at any point along the signal path. The optical isolator 670 may be any device which prevents or diminishes energy propagation in a direction opposite to the desired direction of propagation, similar to a diode in electronics, or a check valve in hydraulics.

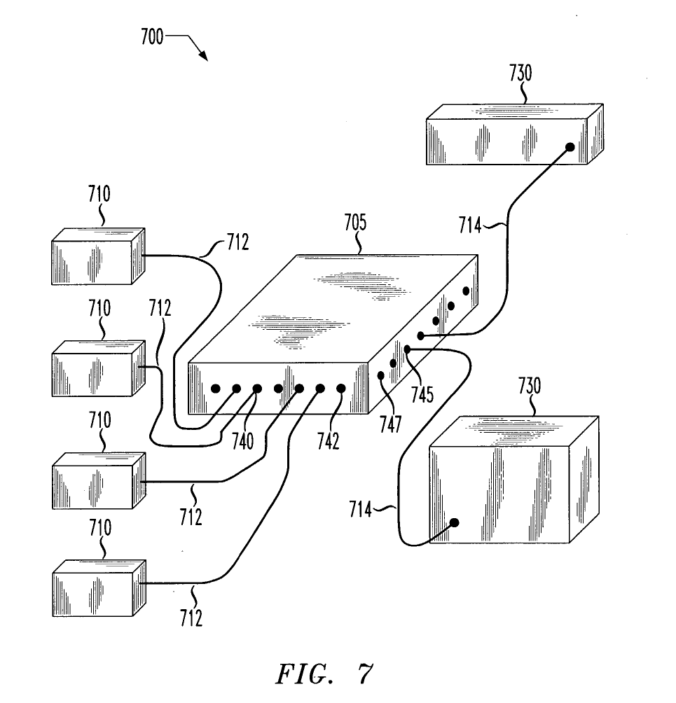

Turning now to FIG. 7, with continued references to FIGS. 2 through 5, illustrated is an optoelectronic sub-system 700 which may be used in accordance with the bulk optical packaged units 200 through 500. It should be understood that the optical device 705 may be one of the configurations as discussed with respect of FIGS. 2 through 5 or another configuration that is in accordance with the present invention. In the embodiment illustrated in FIG. 7, two or more light sources 710 direct input signals through fiber optic pigtails 712 into optical inputs 740. An example of the light source 710 may be a laser pump or other optical transmitter. Optical device 705 multiplexes the input signals and redistributes the multiplexed signal or signals, ultimately directing them toward one or more optical outputs 745 in a manner similar to that of bulk optic packaged units 200 through 500. Fiber optic pigtails 714 then transmit the redistributed signals to one or more optical components 730. As illustrated in FIG. 7, optical device 705 may include additional expansion optical inputs 742 and outputs 747.

In this manner, redundancy of light sources 710 within the optoelectronic sub-system is provided, in that one or more of the light sources 710 may cease providing optical pump power, either for power conservation or due to malfunction or maintenance needs, yet the optical components 730 typically on the optical amplifier may continue to operate, although in some instances at a decreased performance level. It should be understood by those skilled in the art that many combinations of optical sources and optical sub-systems powered by the optical sources may be achieved by the present invention. For example, it is not necessary that the number of pump sources 710 or optical sub-systems 730 be a power of 2 (i.e., 2, 4, 8, 16, 32, etc.), such that the wavelength combining function and signal distribution function need not be symmetric.

The present invention is not limited to the embodiments described above. For instance, an alternative embodiment of an optical device constructed according to the principles of the present invention may include two or more multiplexer elements. In such an embodiment, the distributor is optional. Such an embodiment may be utilized in applications requiring the combination of three or more conventional light sources (pumps), such as for EDFA or Raman applications. For Raman applications, the reduction in pump insertion loss afforded by an alternative embodiment in which one or more polarization-combining elements and one or more WDM-combining elements are present enables the more productive use of semiconductor laser diode pump sources. This alternative embodiment may also include conventional collimators and/or isolator assemblies between the optical inputs or outputs and the WDM elements. Alternative embodiments may also include multiplexer elements selective to signal phase, polarization or another characteristic other than wavelength.

Alternative embodiments may also include application-specific combinations for employing multiplexer elements to combine one or more light sources with energy distributed over a wide range of wavelengths. Specific examples include embodiments that combine light source or pump energy with signal path energy, such as for components for use inside a conventional optical amplifier. Conventional gain flattening filters may also be placed into the signal path through the optical device. Application-specific embodiments may also include sufficient WDM elements, and possibly distributor elements, to service two or more signal paths simultaneously. Accordingly, two discrete optical circuits may be included within a single bulk optics package.

Additional embodiments may also include conventional dual fiber collimators, wherein two fibers terminate within the collimator and provide collimated signals that may diverge from each other by approximately 3.5 degrees, or that may converge to each other from approximately 3.5 degrees of separation. In one embodiment, a reflective filter (e.g., a 2% tap filter, as known to those skill in the art) may be located in close proximity to the collimator or another component within the bulk optics package. A sample of the energy that is entering the optical package by an optical fiber or pigtail may thereby be rerouted out of the optical package to another component. Such embodiments may be employed to permit combination of additional signals into a signal path (not shown). Of course, those skilled in the art understand that such sampling via a tap may occur anywhere along the signal path.

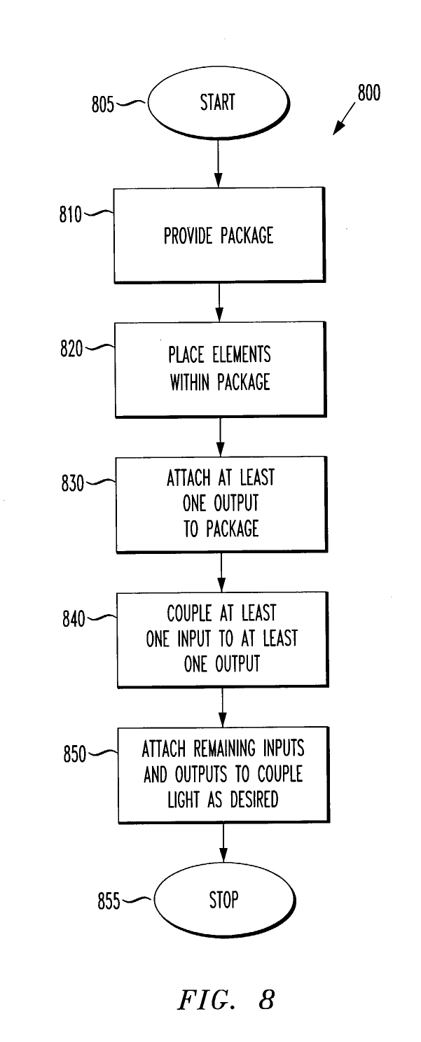

Turning finally to FIG. 8, illustrated is a flow diagram of an embodiment of a method, generally designated 800, of fabricating an optical device constructed in accordance with the principles of the present invention. The method 800 starts in a step 805 with an intent to fabricate an optical device within a bulk optic packaged unit. In a step 810, a bulk optic package unit may be provided. In an exemplary embodiment, the bulk optic package unit that has been provided may include input and output openings or windows where appropriate. The input and output openings and windows may be formed from glass, plastic, or another substantially transparent material, and may further include an anti-reflective coating so as to minimize reflective losses of any light traversing that window. Of course, the windows may be made of no material, viz., a simple hole through which light is directed.

In a subsequent step 820, multiple elements may be placed within the bulk optic package unit. In an exemplary embodiment, the multiple elements may include wavelength division multiplexer (WDM) elements, optical signal distributor elements, directing device elements, and other applicable elements. The number of elements within the bulk optic package unit may vary. For example, in an exemplary embodiment a number of WDM elements should be large enough to appropriately multiplex any input signals, preferably such that all of the input signals are multiplexed into one or two multiplexed signals.

In a subsequent step 830, at least one optical output is attached to the package. The at least one optical output may comprise many devices. For example, in an exemplary embodiment the at least one optical output is an optical waveguide with associated collimator or a signal receiver. One skilled in the art understands how to attach the at least one optical output to the package, including using the previously mentioned transparent windows, if used.

In a step 840, and after attaching the at least one optical output to the package, at least one optical input is coupled to the at least one optical output. The number and type of at least one optical inputs may also vary. In an exemplary embodiment, however, the at least one optical input may comprise a light source, optical waveguide, pump laser, or another similar device. Note, that the number of optical inputs need not equal the number of outputs.

Subsequent to completing the step 840, and in a step 850, any remaining optical inputs and optical outputs may be attached to the bulk optic package unit to couple light as desired. Subsequently, in a step 855, the fabrication of the optical device is complete. Of course, those skilled in the art understand that the steps 805 through 855 may be performed in a different sequence than described above.

Although the present invention has been described in detail, those skilled in the art should understand that they can make various changes, substitutions and alterations herein without departing from the spirit and scope of the invention in its broadest form.

What is claimed is:

1. An optical device, comprising:
a signal multiplexer element; and
a signal distributor element, said signal multiplexer element and said signal distributor element located between an optical input and an optical output and contained within a single optic package unit wherein signals introduced therein propagate in free space between said signal multiplexer element and said signal distributor element.

2. The optical device as recited in claim 1 where said signal multiplexer element is a wavelength division multiplexer element or a polarization dependent combiner element and said signal distributor element is a wavelength division distributor element or a polarization dependent splitter element.

3. The optical device as recited in claim 1 further comprising a substrate, said signal multiplexer element and said signal distributor element being coupled to said substrate, and wherein at least one of said optical input and said optical output is a waveguide couplable to said substrate. 4.

4. The optical device as recited in claim 1 wherein said optical input includes an input opening formed in said optic package unit and said optical output includes an output opening formed in said optic package unit.

5. The optical device as recited in claim 1 wherein said optical input includes a light source and said optical output includes a waveguide that forms a portion of an optoelectronic sub-system further including an optical detector.

6. The optical device as recited in claim 1 further comprising a plurality of optical inputs and optical outputs and a plurality of signal multiplexer elements and signal distributor elements located between said optical inputs and optical outputs, wherein said plurality of optical inputs, optical outputs, signal multiplexer elements and signal distributor elements form one or more independent signal paths.

7. The optical device as recited in claim 1 further comprising a signal director located between said optical input and said wavelength division multiplexer element and within said optic package unit.

8. The optical device as recited in claim 1 wherein said signal multiplexer element is a transparent material having an anti-reflective coating on one side thereof and a multiplexer coating on an opposing side thereof, and said signal distributor element is a transparent material having an anti-reflective coating on one side thereof and a distributive coating on an opposing side thereof, wherein each of said anti-reflective coating and said distributive coating comprise a multi-layer dielectric stack.

9. The optical device as recited in claim 1 further comprising an optical isolator in optical communication with said signal multiplexer element and/or said signal distributor element.

10. The optical device as recited in claim 1 further comprising an optical tap element optically coupled to a collimator and one of said optical input and said optical output.

11. The optical device as recited in claim 10 further comprising an optical detector optically coupled to said optical tap element and having electrical conductors extending outside said optic package unit.

12. The optical device as recited in claim 11 wherein said optical detector includes a partially-reflective coating thereon that both reflects and transmits incident optical energy.

13. The optical device as recited in claim 1 wherein said optical device forms at least a portion of an optical communications system that includes a transmitter or a receiver.

14. The optical device as recited in claim 1 wherein said optical device forms at least a portion of an optoelectronic sub-system, the optoelectronic sub-system further comprising:
an optical light source;
optical input and output waveguides coupled to at least one respective optical input and optical output; and
an optical detector in optical communication with at least one of said optical input and output.

15. The optical device as recited in claim 14 wherein said at least one optical input includes an input opening formed in said optic package unit and said at least one optical output includes an output opening formed in said optic package unit.

16. The optical device as recited in claim 14 further comprising a plurality of optical inputs and optical outputs and a plurality of signal multiplexer elements and signal distributor elements located between said plurality of optical inputs and optical outputs.

17. The optical device as recited in claim 14 further comprising a signal director located between said optical input and said wavelength division multiplexer element and within said optic package unit.

18. The optical device as recited in claim 14 wherein said signal multiplexer element is a transparent material having an anti-reflective coating on one side thereof and a multiplexer coating on an opposing side thereof, and said signal distributor element is a transparent material having an anti-reflective coating on one side thereof and a distributive coating on an opposing side thereof, wherein each of said anti-reflective coating and said distributive coating comprise a multi-layer dielectric stack.

19. The optical device as recited in claim 14 further comprising an optical tap element optically coupled to a collimator and one of said optical input and said optical output.

20. An optical device, comprising:
an optic package unit having a substrate and first and second optical inputs and outputs;
a wavelength division multiplexer coupled to said substrate and having a transflective surface, said transflective surface having a multiplexer coating configured to superimpose first and second incident signals propagating in free space from said first and second optical inputs respectively and having respective first and second wavelengths by reflecting said first signal and transmitting said second signal; and
an optical signal distributor coupled to said substrate and having a distributive coating on a surface thereof, said distributive coating configured to split said superimposed first and second signals by reflecting a first portion of said superimposed first and second signals toward said first optical output in free space and transmitting a second portion of said superimposed first and second signals toward said second optical output in free space.
